(19) United States
(12) Patent Application Publication
(10) Pub. No.: US 2005/0033753 A1
(43) Pub. Date: Feb. 10, 2005

(54) SYSTEM AND METHOD FOR MANAGING TRANSCRIPTS AND EXHIBITS

(76) Inventors: Grover Mundell, Aurora, CO (US); Kevin Koch, Denver, CO (US)

Correspondence Address: HOLLAND & HART, LLP, 555 17TH STREET, SUITE 3200, DENVER, CO, 80201, US

(21) Appl. No.: 10/710,813

(22) Filed: Aug. 4, 2004

Related U.S. Application Data
(60) Provisional application No. 60/493,994, filed on Aug. 8, 2003.

(51) Int. Cl. G06F 17/00

(52) U.S. Cl. 707/100

(57) ABSTRACT

The present invention provides a method for managing electronic transcripts and electronic exhibits. In particular, the present invention provides a system that allows a user defined association between an electronic transcript and at least one electronic exhibit.

### RELATED APPLICATIONS

This application incorporates by reference U.S. patent application Ser. No. filed July 2001, entitled “Transcript Management Software and Method Therefor U.S. patent application Ser. No. filed March 2002, entitled “Methods for Synchronizing On-Line and Off-Line Tran-script Projects; U.S. provisional patent application Ser. No. 60/494,061, filed Aug. 7, 2003, titled “Computer Program Product Containing Electronic Transcript and Exhibit Files and Method for Making the Same, ” and incorporated herein by reference as if set out in full; and U.S. patent application Ser. No. 10/710,796, titled “Computer Program Product Containing Electronic Tran-script and Exhibit Files and Method for Making the Same,” filed Aug. 3, 2004, and incorporated herein as if set out in full. The present application claims priority to pending provisional application Ser. No. 60/493,994, filed Aug. 8, 2003, titled System and Method for Managing Transcripts and Exhibits, which application is incorporated herein by reference as if set out in full.

### BACKGROUND

Presently, many people receive electronic copies of court proceedings, such as, for example, depositions, court transcripts, testimony, or the like, electronically (generically referred to as “electronic transcripts”). The electronic transcript provides a good tool to navigate and full text search the transcript and has proven useful for a number of reasons.

Conventionally, however, court proceedings, such as, for example, depositions include the use of written materials, such as exhibits. In this case, the exhibits are often only available with the written transcript. Sometimes, the exhibits are converted into electronic format, such as by scanning, and appended to the electronic transcript. Unfortunately, while accessible electronically, the association and use of the electronic exhibit is not very convenient, fixed, bulky, and frequently difficult to coordinate.

Thus, it would be desirous to develop systems and method for managing transcripts and exhibits.

### FIELD OF THE INVENTION

The present invention relates to electronic transcripts and associated electronic exhibits and, more particularly, systems and method to manage electronic transcripts and associated exhibits that are converted into digital form.

### SUMMARY OF INVENTION

The present invention relates to systems and method for managing transcripts and exhibits electronically. In particular, the present invention provides systems and methods for managing electronic transcripts and exhibits. In particular, the methods provide for selection and electronic transcript to be associated with an electronic exhibit. As association tool is displayed and the user-de-fined association is provided. The user-defined association is identified with at least one exhibit, and the association is applied to the transcript such that the associated exhibit can be displayed as desired by the user.

The foregoing and other features, utilities and advantages of the invention will be apparent from the following more particular description of a preferred embodiment of the invention as illustrated in the accompanying drawings.

### BRIEF DESCRIPTION OF DRAWINGS

The accompanying drawings illustrate various embodiments of the present invention and are a part of the specification. The illustrated embodiments are merely examples and illustrations of the present invention and do not limit the scope of the invention.

FIG. 1 illustrates a functional block diagram of an operating environment in which the present invention may function;

FIG. 2 illustrates a functional block diagram of a transcript management system consistent with an embodiment of the present invention;

FIG. 3 is a flowchart illustrating one operation consistent with an embodiment of the present invention;

FIG. 4 is a flowchart illustrating another operation consistent with an embodiment of the present invention;

FIG. 5 is one possible graphical user interface consistent with an embodiment of the present invention;

FIG. 6 is a flowchart illustrating yet another operation consistent with an embodiment of the present invention; and

FIG. 7 is one possible graphical user interface consistent with an embodiment of the present invention useful for the operation of FIG. 6.

### DETAILED DESCRIPTION

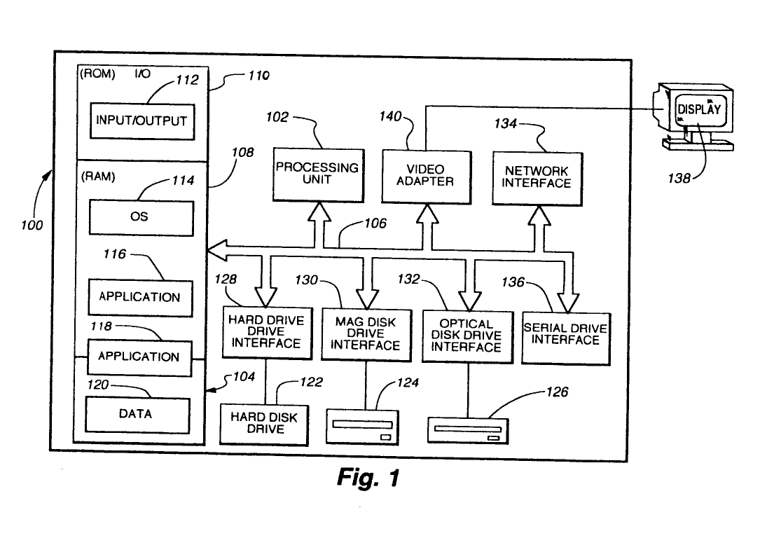

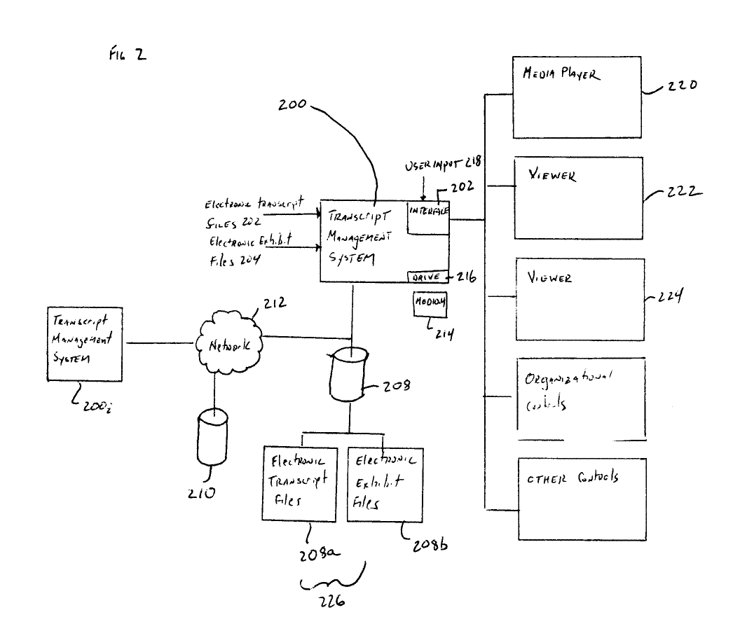

With reference to FIGS. 1-7, an embodiment of the present invention will be described. The present invention relates to systems and methods for improving the association between electronic transcripts and electronic exhibits, particularly in transcripts and exhibits relating to court or legal proceedings. The present invention is described as operating on a personal computer, but one of ordinary skill in the art would appreciate that the invention could be implemented on other systems, such as, hand-held devices, multiprocessor systems, local area networks (LANs), wide area networks (WANS), wireless networks (WLANs), optical networks, Ethernet, Internet, World Wide Web, microprocessor based or programmable consumer electronics, mainframe systems, multiple server systems, or the like. Upon reading the disclosure, one of ordinary skill in the art will now recognize that alternate and equivalent embodiments of the present invention are possible and may be made without departing from the spirit and scope of the present invention.

With reference to FIG. 1, a conventional personal computer 100 capable of implementing the present invention will be described. Generally, personal computer 100 includes a processing unit 102, a system memory 104, and a system bus 106. System bus 106 couples the various system components and allows data to be exchanged between the components. System bus 106 could operate on any number of conventional bus protocols. System memory 104 generally comprises both a random access memory (RAM) 108 and a read only memory (ROM) 110. Other types of memory, such as DRAM, SDRAM, or the like could be included as well.

ROM 110 generally stores basic operating information systems such as a basic input/output system (BIOS) 112. RAM 108 often contains the basic operating system (OS) 114, application software 116 and 118, and data 120.

Personal computer 100 generally includes one or more of a hard drive 122, a magnetic disk drive 124, or an optical disk drive 126. The drives are connected to the bus 106 via a hard disk drive interface, a magnetic disk drive interface 130, and an optical disk drive interface 132. Application modules and data may be stored on a disk, such as, for example, hark disk installed in the hard disk drive (not shown).

Personal computer 100 also may have network connection 134 to a network, such as, for example, a LAN, WAN, WLAN, WiFi, Optical, Ethernet, Internet, or the World Wide Web, and/or a serial port 136, USB or the like to connect to peripherals, such as a mouse, keyboard, modem, speakers (internal or external) or a printer. Personal computer may also have USB ports or wireless components as are generally known in the art.

Personal computer 100 typically has a display or monitor 138 connected to bus 106 through an appropriate interface, such as a video adapter 140. On reading this disclosure, those of ordinary skill in the art will recognize that many of the components discussed as separate units may be combined into one unit and individual units may be split into several different units. Further, the various functions and components could be located in a single device, or spread over several local and/or remote devices using, for example, a network.

If personal computer 100 is connected to a network, typically one or more remote network servers exist to manage the network resources. The network server may be another personal computer (or personal computer 100 could act as the server), a server, or other equivalent device.

In the description that follows, the present invention may be described with reference to parts of personal computer 100. However, it should be understood that such references are exemplary and not to limit the present invention to the above-described operating environment as those skilled in the art will appreciate that various operating environments may implement the present invention.

Embodiments of the present invention provide various features for use with a transcript management system, which may be embodied in software (as used herein, the terms software, systems, modules, computer code devices, computer programs are used interchangeably) operating on a processor, such as personal computer 100 above. Transcript management systems in accordance with embodiments of the present invention provide a user with the ability to manage various electronic transcripts and exhibits and arrange them, for instance as projects or files. Transcript management systems are provided with exhibit handling capabilities so that scanned digital images of exhibits, imported files, streamed files or the like can be input and managed within the electronic transcript management software. Accordingly, a user of the transcript management software may browse, organize, and/or review both electronic transcripts and exhibits for particular projects or court cases. Various embodiments of the invention will now be described.

FIG. illustrates a function block diagram of transcript management system 200 operating on personal computer 100. In FIG. the transcript management system 200 receives electronic transcript files 202 and exhibit files 204. In one example, the files may be obtained from bundles or collections of selected transcripts and exhibits that are stored in a file, written to a medium 214, such as a hard disk, magnetic disk, or optical disk, or the like. Medium 214 would be inserted into an appropriate drive 216.

When stored in a file (or files), the file may be stored in a memory. The memory may be, for example, a local memory 208 that stores projects consisting of electronic transcript files 208a and electronic exhibit files 208b. Exhibit file 208b may be a video file, an audio file, an audio/video file, a still image, a textual document, or imported from a scanner as a TIF, PDF, JPG, bitmap, GIF format file. Instead of being located locally, the memory may be remote memory 210 that is accessible though a network 212. When accessible through a network 212, other transcript management systems 200 may have access to the files. Thus, conventional security protocols should be implemented.

Transcript management system 200 also provides a user interface 202. User interface 202 accepts user input 218 from any conventional source, such as, for example, a keyboard, a mouse, a pointer, a light pen, a touch-screen, etc. User interface 202 provides displays for the electronic transcript files, electronic exhibit files, control interfaces, and the like. For example, user interface may provide a media player 220 provides the ability to play audio, video, audio video and the like. A first viewer 222 provides the ability to display electronic transcript files. A second viewer 224 provides the ability to display electronic exhibit files. Media player 220 and viewers 222 and 224 are configured for whatever formats the media and/or files are stored. For example, the media player 220 may be configured to display MPEG files, the first viewer may be configured to display electronic transcript files, the second viewer may be configured to display pdf or jpeg files. The number of viewers should coincide with the number of viewers necessary to display the transcripts, exhibits, and the like.

When the projects are saved to a medium 214, such as, for example, a magnetic disk or an optical disk, the files and viewers may be stored on the medium 214 and launched when installed or on an as needed basis. Also, files 208a and 208b may be bundled into bundles 226. Bundles 226 may include executable code to launch, load, or install viewers as necessary.

User interface 202 may receive user input through a conventional input devices associated with BIOS 112. Such controls may include keyboard, mouse, pointer, touch pads, light pen, or other input devices. It is envisioned, however, that organizational controls 228 would mostly be point and click style controls, but any of the aforementioned or other devices are possible. Other controls 230 include dialog boxes, popup menus, pull down menus, and the like. While separated for convenience, organizational controls 228 and other controls 230 could be described as a single entity or many entities as desired.

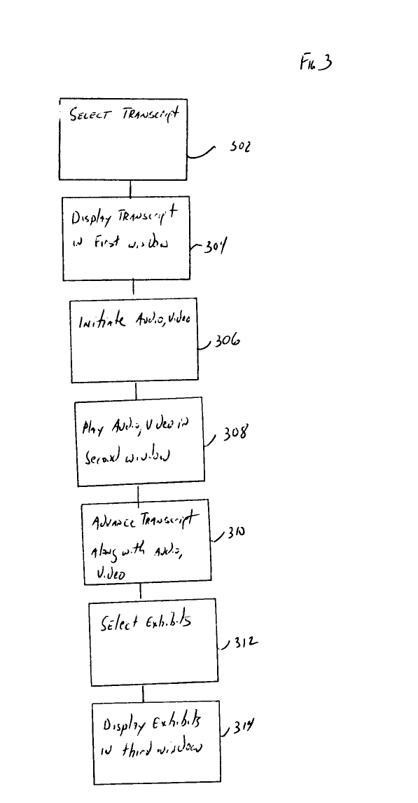

Viewers 222 and 224 are provided as separate because transcript viewers or windows are preferably separately displayable and controllable from exhibit viewers or windows. Similarly, if an audio, video of a legal deposition was taken, transcript management system 200 could synchronize the audio, video with the electronic transcript such that the following may occur. Referring specifically to FIG. 3, an electronic transcript could be selected, step 302, and displayed in a first window, step 304. Next, a synchronized audio, video of the transcript is initiated, step 306, and played in a second window, step 308. The transcript in the first window would indicate the text as it is spoken in the video/audio and advance along with the audio/video, step 310. Optionally, any associated exhibits may be selected, step 312, and displayed in a third window, step 314. Notice, the selecting and displaying of the exhibits in the third window could be accomplished automatically.

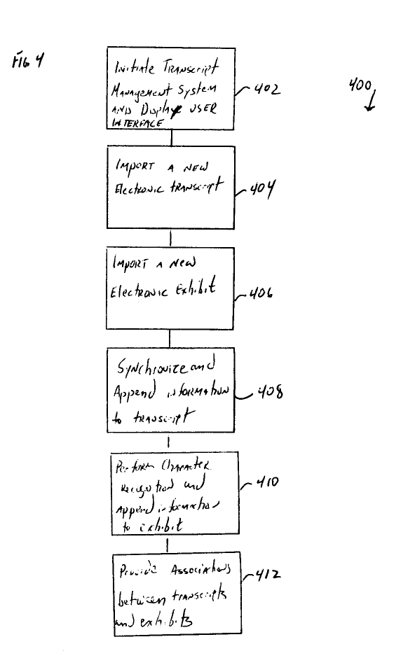

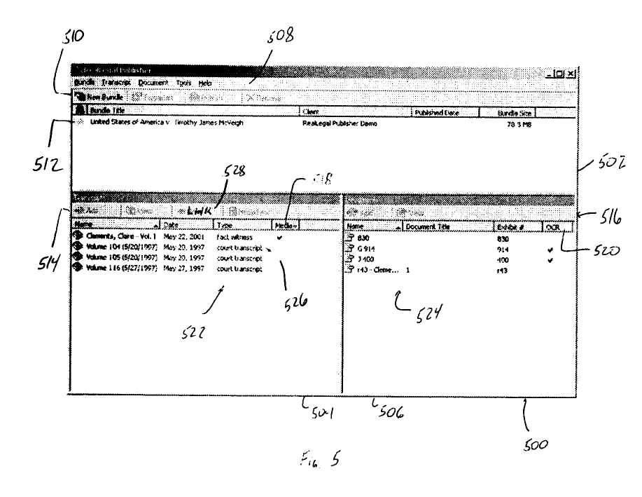

Referring now to FIG. 4, a flowchart 400 is provided illustrating an operation of the transcript management system 200. The operation described in flowchart 400 is explained in conjunction with interface 500 shown in FIG. 5. First, transcript management system 200 initiates and displays user interface 500, step 402. User interface 500 is split into three distinct panels (although that is a matter of design choice). Panel 502 is a project or bundle panel. Panel 504 is a transcript panel. Panel 506 is an exhibit panel, exhibits are generically referred to as documents. Panel 502 contains a tool bar 508 that provides controls to allow a user to organize various bundles or projects. For example, tool bar 508 may have a new bundle tool 510 or other tools, such as, for example, a remove tool, a duplicate tool, or the like. Tool bar 508 may have controls to add information to transcript panel 504 and exhibit panel 506.

Bundle panel 502 currently includes a single project or bundle 512, titled United States of America v. Timothy James McVeigh. By highlighting bundle 512, transcript panel 504 and exhibit panel 506 are populated with transcript files and exhibit files already associated with the bundle 512. Additional transcripts and exhibits may be imported.

Referring back to FIG. 4, we will assume the transcript management system 200 has already been populated in part, as shown in FIG. 5. To add a new transcript to bundle 512, the user imports a new transcript from electronic transcript files 208a, for example, step 404. Importation of the transcript can be accomplished using tool bar 508 by clicking on the transcript pull down menu, which allows the user to select or browse for electronic transcript files and select a transcript to be imported. Alternatively, the user could access transcript tool bar 514 and select the add function. To add a new exhibit to bundle 512, the user imports a new exhibit from electronic exhibit files 208b, for example, step 406. Again the user can accomplish this by using tool bar 508 or exhibit tool bar 516.

As mentioned above, the transcript may have a media file associated with it, such as, for example, a video taped deposition. In this case, the media file can be synchronized and appended to the electronic transcript in a conventional manner, step 408. A synchronized and appended media file would be indicated in a media field 518. The media could be launched with the display of the transcript or separate.

Similarly, exhibit files could have character recognition performed to allow text searching of the exhibits. The character recognition would be done in conventional manners and appended to the exhibit, step 410. If the exhibit file has character recognition, it would be indicated in OCR field 520.

While transcript panel is shown as having a specific annotation relating to media and exhibit panel is shown as having a specific annotation relating to character recognition, other types of annotations are possible. For example, notes and information taken by an attorney during a deposition may be annotated to the electronic information, bates numbers may be added, authentication information, or the like may be added.

Once the bundle is populated, as for example, in FIG. 5, associations between the electronic transcripts 522 and 524 are provided, step 412. Transcripts 522 may have no exhibits, one exhibit, or many exhibits associated. Exhibits 524 may also be associated with no transcripts, one transcript, or many transcripts. However, it would be unusual to populate exhibit panel 506 with an exhibit that was not associated with a transcript 522.

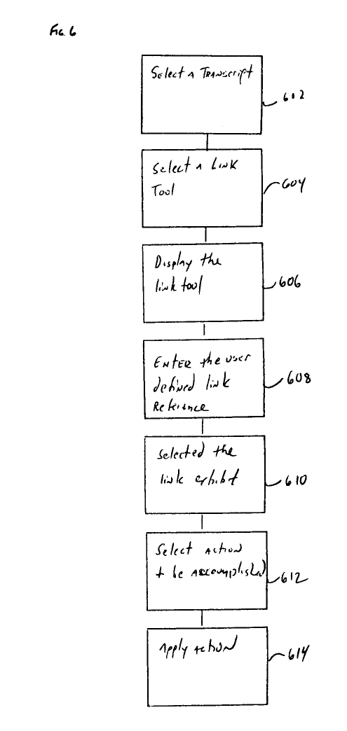

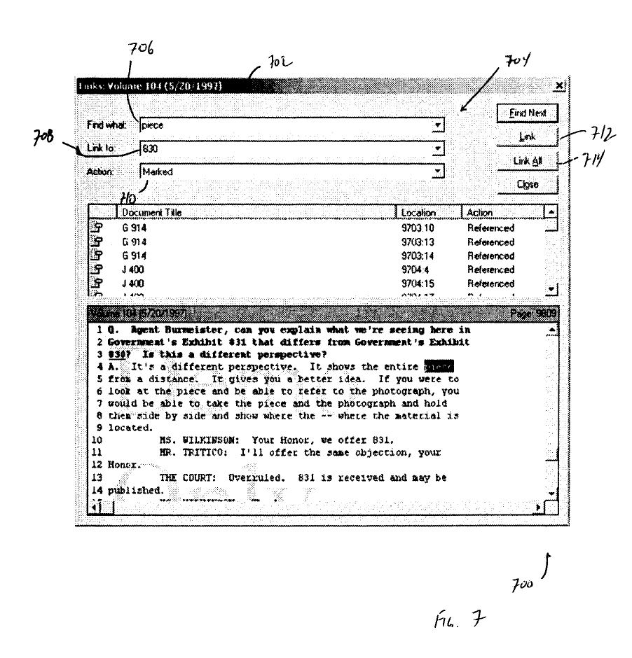

Referring to FIG. 6, a flowchart 600 is provided illustrating one embodiment of establishing the association between the transcript files 522 and exhibit files 524. Flowchart demonstrates associating the transcript to the exhibits, but the alternative is also possible. Further, FIG. 6 describes using a hyperlink, but any conventional association between the files is possible. Flowchart 600 will be explained with reference to panel 500 and to display 700 in FIG. 7.

To establish associations, or links, a transcript is selected, step 602. In this case, transcript 526 is selected (FIG. 5).

The user next selects the link tool 528 on transcript tool bar 514, step 604. A link display 700 is then displayed to the user, step 606. Link display 700 is exemplary. Link display 700 may have a title bar 702 for information and/or navigation. Link display 700 provides a dialog box 704 that includes a find what box 706, a link box 708, and an action box 710. Find what box 706 is a full text search tool that allows the user to search the selected transcript for whatever text, symbol, or the like the user desires. The link box provides what the text in the find box should be linked to, and the action box provides the action to be accomplished. For example, once the link display is displayed, the user would enter the desired textual link phrase, step 608. Textual is used generically, and could be any of a graphical or alphanumerical link. In this case, the user selected the phrase “piece.” Next, the user would select what exhibit the phrase “piece” should be associated with, step 610. In this case, the user selected that “piece” should be associated with exhibit 830. Alternatively, the user can navigate the transcript text pane and select the specific text or area to be associated. Finally, in the action box, the user selects the action the transcript management system 200 should take, step 612. In this case, the system 200 should mark the text “piece” to indicate a link to exhibit 830. Whether a particular text reference to “piece” should be linked to exhibit 830 is determined by the user by indicating a link should be placed, step 614, in other words, should the indicated action be applied. This action is initiated by activity button 712. Alternatively to a phrase-by-phrase linking, a user could select the link all activity button 714 to link all occurrences of “piece” to exhibit 830. Finally, piece could be linked to multiple exhibits by providing multiple links. While the above has been described with reference to a particular word, the association tool provides full user designation. In other words, the user could link based on page numbers, line numbers, page and line numbers, exhibit numbers, bates numbers or ranges, or the like. Alternatively, when the transcript management software imports files, such as XML files, that contain electronic transcript files and exhibit image files, the transcript management software may, in one example, automatically create hyperlinks between the exhibit's introduction points and the respective transcripts. The transcript management system may search or parse the transcript text for identifiers such as the word “EXHIBIT” or “EX” or “EXH-” or other identifiers of exhibits. Once the transcript management software locates an occurrence of such identifier, the transcript management software may examine the field or text immediately following the identifier in order to extract the exhibit number from the transcript text. Having located the first occurrence or mention of a particular exhibit number within the transcript text, the transcript management software may then create an automatic link between this text and the exhibit image file. In one example, each exhibit image file is assigned an exhibit number by the user, preferably the same exhibit number as used within the transcript text. Hence, the transcript management software can automatically link or associate the first occurrence, or each occurrence, all occurrences or selected occurrences of a particular exhibit number referenced in the electronic transcript text with a particular exhibit image.

The example of various operations of system 200 may include one or more of the operations shown above in the same or different order, and one or more of the operations may be combined or subdivided.

In one example, the bundles may be downloaded to memory from transcript management system 200 which might be represented as a web application or service. Once downloaded, the bundles may be uploaded into transcript management system 200 form operations, such as, adding or removing a transcript, adding or removing an exhibit, establishing additional or removing pervious associations, and the like. Ideally, downloading and uploading does not influence previous annotations, notes, associations, or the like. Preferably, when a bundle is imported, only transcripts and exhibits within the bundle that have not been already imported into the transcript management system will be uploaded. Further, annotations, notes, or other information would be synchronized with other versions of the bundle.

In another example, the transcript management system updates a project with the information stored in a bundle. For instance, assume the project is stored on an external, removable media such as a CDROM that contains electronic transcripts and/or exhibit files associated with the project. When the user loads the media, the transcript management system will update any related projects with the information stored on the CDROM, such as associations between particular exhibit files and electronic transcripts. If the transcript management system already contains transcripts, exhibits, OCR, annotations, links, or the like are also found in the bundle they are preferably detected and updated if necessary. For example, in one instance a draft transcript in the system could be updated with the final transcript in the bundle, preferably resulting in a single transcript in the system instead of two.

In another embodiment, the transcript management software may be provided with project synchronization, wherein if a user is utilizing a project (including electronic transcripts and exhibit images) in an off-line manner, then when the user reconnects the computing device to the network, the transcript management software determines whether any changes or updates have occurred to the electronic transcript or exhibit files and if so properly synchronizes the project. For example, if a user is using a project or bundle having an electronic transcript that is not the latest electronic transcript, the transcript management system will synchronize the user's project or bundle by associating the latest electronic transcript with the user's project or bundle. Further, the transcript management software also associates any annotations or any references or hyperlinks to exhibits that the user had previously associated with the prior version of the electronic transcript.

In another example, transcript management system 200 may provide reports generated based on issue codes or search queries created by the user through fields, controls, menus, and/or dialog boxes. In one example, the reports contain a list of portions of a transcript that satisfy the particular query or have been marked by a user as corresponding to one or more particular issue codes. The results of the report may be viewed in a browser window via an internet connection or other conventional report generation technology, and in one embodiment, the results may be saved as an XML file with an XSL specifier which describes how the XML file/data should be transformed into HTML so that the results of the report can be viewed in a browser window. In another example, the transcript management software may provide for a user to e-mail the reports to other users as an XML file or an HTML file as desired.

While the methods disclosed herein have been described and shown with reference to particular steps and/or operating environments, it should be understood that these steps may be combined, sub-divided, or reto form an equivalent method without departing from the teachings of the present invention. Accordingly, unless specifically indicated herein, the order and grouping of the steps is not a limitation of the present invention.

While the invention has been particularly shown and described scribed with reference to various embodiments thereof, it will be understood by those skilled in the art that various other changes in the form and details may be made without departing from the spirit and scope of the invention.

1. A method for managing electronic transcripts and electronic exhibits performed on at least one processor, the method comprising the steps of:
selecting an electronic transcript file to associate with at least one electronic exhibit;
displaying the association tool;
inputting a user defined association between the electronic transcript and the electronic exhibit;
identifying at least one electronic exhibit to be associated with the electronic transcript by the user defined association;
choosing a type of association between the electronic transcript and the at least one electronic exhibit; and
applying the association to the electronic transcript such that the electronic transcript and the at least one electronic exhibit are associated.

2. The method of claim 1, wherein the type of association is a link from the electronic transcript to the at least one electronic exhibit.

3. The method of claim 2, further comprising the steps of:
activating the applied association; and
displaying the at least one electronic exhibit.

4. The method of claim 3, further comprising the steps of:
displaying the electronic transcript in a first window; and
displaying the at least one electronic exhibit in at least a second window.

5. The method of claim 3, wherein the step of displaying the at least one electronic exhibit comprises the step of displaying an image.

6. The method of claim 3, wherein the step of displaying the at least one electronic exhibit comprises playing an audio file.

7. The method of claim 3, wherein the step of displaying the at least one electronic exhibit comprises playing a video file.

8. The method of claim 3, wherein the step of displaying the at least one electronic exhibit comprises playing an audio/video file.

9. The method of claim 1, further comprising the steps of:
synchronizing a media file with the electronic transcript;
and
appending the media file to the electronic transcript.

10. The method of claim 9, further comprising the step of launching the media file in a media window.

11. The method of claim 10, further comprising the step of advancing the electronic transcript along with the media file.

12. The method of claim 11, wherein the at least one electronic exhibit is displayed as the electronic transcript is advanced past the association.

13. The method of claim 1, further comprising the step of recognizing the characters of the at least one electronic exhibit to provide character searching of the at least one electronic exhibit.

14. The method of claim 1, further comprising the step of importing a file to a project, the file selected from a group of files consisting of electronic transcript files and electronic exhibit files.

15. A system for managing electronic transcripts and electronic exhibits, comprising:
a transcript manager;
an organizational and control module connected to the transcript manager to provide tools;
a memory comprising at least one electronic transcript file and at least one electronic exhibit file connected to the transcript manager; and
a display connected to the transcript manager, the display providing at least a graphical user interface and at least one viewer, such that the transcript manager provides a graphical user interface and the organizational control module provides tools whereby a user can manage the at least one electronic transcript and the at least one exhibit.

16. The system of claim 15, wherein the memory comprises a local memory connected to the transcript manager.

17. The system of claim 15, wherein the memory comprises at least a remote memory connected to the transcript manager through a network connection.

18. The system of claim 17, wherein the network is selected from a group of networks consisting of a local area network, a wide area network, an optical network, a wireless network, a WiFi network, an Ethernet, Internet, and World Wide Web.

19. The system of claim 15, wherein the memory comprises a removable medium.

20. The system of claim 19, wherein the removable medium is selected from the group consisting of a magnetic disk, an optical disk, and a tape.

21. The system of claim 15, wherein the graphical user interface receives user input from an input device selected from a group consisting of a keyboard, a mouse, a track ball, a light pen, and a touch screen.

22. The system of claim 15, wherein the display provides a first display to display the at least one electronic transcript and a second display to display the at leas tone electronic exhibit.

23. The system of claim 22, further comprising a media player to display media selected from a group of media consisting of audio, video, and audio/video.

24. The system of claim 15, further comprising at least one dialog box in which a user can enter a user defined association between the at least one electronic transcript and the at least one electronic exhibit.
